(19) United States
(12) Patent Application Publication
(10) Pub. No.: US 2017/0283053 A1
(43) Pub. Date: Oct. 5, 2017

(54) UNINHABITED AERIAL VEHICLE, UNINHABITED AERIAL VEHICLA CONTROL SYSTEM, AND UNINHABITED AERIAL VEHICLE CONTROL METHOD

(71) Applicant: NEC CORPORATION, Tokyo (JP)

(72) Inventors: Hirotake TODA, Tokyo (JP); Ken KASAGI, Tokyo (JP)

(73) Assignee: NEC CORPORATION, Tokyo (JP)

(21) Appl. No.: 15/465,722

(22) Filed: Mar. 22, 2017

(30) Foreign Application Priority Data
Mar. 29, 2016 (JP) 2016-065119

(51) Int. Cl. B64C 39/02; G06T 7/70; G08G 5/00

(52) U.S. Cl. CPC B64C 39/024; G08G 5/0013; G08G 5/003; G06T 7/70; B64C 2201/125; B64C 2201/146; G06T 2207/30252

(57) ABSTRACT

An uninhabited aerial vehicle includes: a calculator that calculates position information indicating a position and an altitude of the vehicle; an image capturing unit that captures an image; a lightning rod; a controller that controls the position and altitude of the vehicle; and a communicator which performs information communication, wherein the calculator transmits the position information to the communicator, the image capturing unit calculates a position of an object to be protected against a thunderbolt from the image, and transmits the calculated position to the communicator, the communicator transmits the position information received from the calculator and the position of the object received from the image capturing unit to the outside, and receives flight instruction information, and the controller controls the position and the altitude of the vehicle based on received flight instruction information of the received flight instruction information.

This application claims priority based on Japanese Patent Application No. 2016-065119 filed on Mar. 29, 2016, the disclosure of which is incorporated herein in its entirety.

### TECHNICAL FIELD

The disclosed subject matter relates to a device and the like which can prevent a thunderbolt from striking an object to be protected.

### BACKGROUND ART

Lightning rods are placed on iron towers or the rooftops of buildings at high altitudes to prevent thunderbolts from striking an important facility, a person, and the like. A lightning rod is implemented in a rod-like conductor having a sharp tip and is placed at the tip point of a building or the like to be protected. Upon a thunderbolt, lightning is attracted to the lightning rod and guided to the ground. This prevents damage to the building or the like.

The zones in which lightning rods make thunderbolts far less likely to occur are called lightning protection areas or lightning protection zones. Various researches and investigations have been conducted for such lightning protection areas, which are confirmed to be limited to zones having an altitude lower than the tip of lightning rods. According to the current JIS (Japanese Industrial Standards), a zone within a cone which extends vertically downwards from the tip of a lightning rod and has a vertex angle of 55° or less is specified as a zone in which a thunderbolt is prevented. This vertex angle is often called the angle of protection of the lightning rod. According to JIS, the higher the altitude of the tip of a lightning rod, the smaller the angle of protection of the lightning rod.

PTL 1 discloses a structure of a lightning rod for widening the lightning protection area.

### CITATION LIST

### Patent Literature

[PTL 1] Japanese Unexamined Patent Application Publication No. H5-121192

### SUMMARY OF INVENTION

### Technical Problem

Unfortunately, the lightning protection area widened by the lightning rod disclosed in PTL 1 is limited. The lightning protection areas are still limited to zones having an altitude lower than the tips of lightning rods. Therefore, at locations where no lightning rods can be placed at high altitudes, such as the sea, lakes, golf courses, and mountainous regions, the lightning protection areas of lightning rods are too limited for measures against thunderbolts.

It is an object of the disclosed subject matter to provide a device and a method which can prevent a thunderbolt from striking an object to be protected, at a location where no lightning rod can be placed at a high altitude.

### Solution to Problem

An uninhabited aerial vehicle according to the disclosed subject matter includes a calculation unit which calculates position information indicating a current position and altitude of the uninhabited aerial vehicle, an image capturing unit which captures an image, a lightning rod, a conducting wire including a lead which is coupled to the lightning rod and has one end grounded, a control unit including a functional unit which controls a position and an altitude of the uninhabited aerial vehicle, and a communication unit which performs information communication with an outside, wherein the calculation unit transmits the position information to the communication unit, the image capturing unit calculates a position of an object to be protected against a thunderbolt from the captured image and transmits the calculated position of the object to the communication unit, the communication unit transmits the position information received from the calculation unit and the position of the object received from the image capturing unit to the outside, and receives flight instruction information based on the position information and the position of the object from the outside, and the control unit controls the position and the altitude of the uninhabited aerial vehicle on the basis of the received flight instruction information.

An uninhabited aerial vehicle control system according to the disclosed subject matter includes an uninhabited aerial vehicle including a calculation unit which calculates position information indicating a current position and altitude of the uninhabited aerial vehicle, an image capturing unit which captures an image, a lightning rod, a conducting wire including a lead which is coupled to the lightning rod and has one end grounded, a control unit including a functional unit which controls a position and an altitude of the uninhabited aerial vehicle, and a communication unit which performs information communication with an outside, and a ground station, wherein the calculation unit transmits the position information to the communication unit, the image capturing unit calculates a position of an object to be protected against a thunderbolt from the captured image and transmits the calculated position of the object to the communication unit, the communication unit transmits the position information received from the calculation unit and the position of the object received from the image capturing unit to the ground station, the ground station calculates flight instruction information on the basis of the received position information and the received position of the object and transmits the calculated flight instruction information to the communication unit, the communication unit receives the flight instruction information from the ground station, and the control unit controls the position and the altitude on the basis of the received flight instruction information.

An uninhabited aerial vehicle control method according to the disclosed subject matter includes calculating a current position including an altitude as position information, capturing an image, calculating a position of an object to be protected against a thunderbolt from the captured image, transmitting the position information and the position of the object to an outside, receiving flight instruction information based on the position information and the position of the object from the outside, and controlling a position and an altitude of an uninhabited aerial vehicle on the basis of the received flight instruction information.

### Advantageous Effects of Invention

According to the disclosed subject matter, a thunderbolt can be prevented at a location where no lightning rod can be placed at a high altitude.

### [BRIEF DESCRIPTION OF DRAWINGS]

FIG. 1 is a block diagram illustrating the configuration of an uninhabited aerial vehicle according to an exemplary embodiment of the disclosed subject matter.

FIG. 2 is a conceptual diagram illustrating the configuration of an entire uninhabited aerial vehicle control system according to the exemplary embodiment of the disclosed subject matter.

FIG. 3 is a sequence chart illustrating the operation of the uninhabited aerial vehicle control system according to the exemplary embodiment of the disclosed subject matter.

FIG. 4 is a diagram for explaining an exemplary method for calculating the position (longitude and latitude) and the altitude (flight instruction information) of the uninhabited aerial vehicle, which calculation method is conducted by a ground station according to the exemplary embodiment of the disclosed subject matter.

FIG. 5 is a diagram for explaining another exemplary method for calculating the position (longitude and latitude) and the altitude (flight instruction information) of the uninhabited aerial vehicle, which calculation method is conducted by the ground station according to the exemplary embodiment of the disclosed subject matter.

### DESCRIPTION OF EMBODIMENTS

An exemplary embodiment of the disclosed subject matter will be described in detail below with reference to the drawings. In the following description, the same reference numerals denote parts having the same functions, and a description thereof may be omitted.

(Configuration)

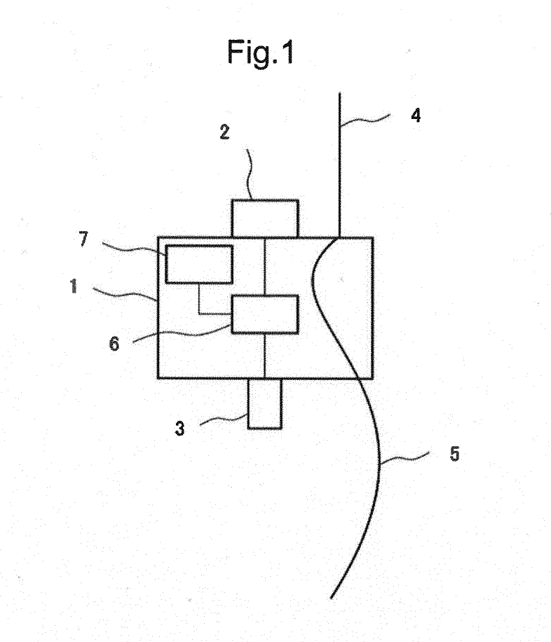

FIG. 1 is a block diagram illustrating the configuration of an uninhabited aerial vehicle according to an exemplary embodiment of the disclosed subject matter.

An uninhabited aerial vehicle 1 according to the exemplary embodiment of the disclosed subject matter includes a GPS 2, a camera unit 3, a lightning rod 4, a conducting wire 5, a control unit 6, and a communication unit 7.

The GPS 2 calculates a current position of the uninhabited aerial vehicle 1. The GPS 2 serves as a receiver for a satellite navigation system such as the GPS (Global Positioning System). Other examples of the satellite navigation system include the GLONASS (Global Navigation Satellite System) and the QZSS (Quasi-Zenith Satellite System). The GPS 2 finds some of artificial satellites launched into the sky, receives signals from these found satellites, and calculates position information including the position (longitude and latitude) and the altitude of the uninhabited aerial vehicle 1. Alternatively, the GPS 2 may calculate position information using, for example, the field strength of a radio wave from a radio base station for mobile phones. The GPS 2 may also be called a calculation unit because such GPSs calculate position information. The GPS 2 transmits the calculated position information to the camera unit 3 and the communication unit 7.

The camera unit 3 serves as an image capturing unit which captures an image of an external landscape. The camera unit 3 is mounted on the uninhabited aerial vehicle 1 to face the ground. The camera unit 3 detects a person, an important building, and the like from the captured image. Such a person, an important building, and the like are objects to be protected against a thunderbolt. The camera unit 3 calculates the position (longitude, latitude, and altitude) of the detected person, the detected important building, and the like using the received position information. The camera unit 3 transmits the calculated position (longitude, latitude, and altitude) of the person, the important building, and the like to the communication unit 7.

The lightning rod 4 is implemented in a rod-like conductor having a sharp tip.

The conducting wire 5 is implemented in a lead having its one end grounded. The conducting wire 5 has the other end coupled to the lightning rod 4. With this configuration, a lightning protection area is formed below the uninhabited aerial vehicle 1 as a zone in which thunderbolts are far less likely to occur. The lightning protection area may be referred to as the lightning protection area of the lightning rod hereinafter.

The control unit 6 serves as a functional unit which controls the operation of the uninhabited aerial vehicle 1.

The communication unit 7 serves as a functional unit which performs information communication with the outside. The communication unit 7 transmits the position information received from the GPS 2 and the position (longitude, latitude, and altitude) of the person, the important building, and the like received from the camera unit 3 to a ground station 8.

The ground station 8 calculates the position (longitude and latitude) and the altitude of a plurality of uninhabited aerial vehicles 1, at which all the objects to be protected fall within the lightning protection area, on the basis of the received position information and position (longitude, latitude, and altitude) of the person, the important building, and the like, and transmits the calculated position and altitude to the communication unit 7 of each of the plurality of uninhabited aerial vehicles 1. The calculated position and altitude will be referred to as flight instruction information hereinafter.

Upon receiving the flight instruction information, the communication unit 7 transmits it to the control unit 6. The control unit 6 controls the position (longitude and latitude) and the altitude of the uninhabited aerial vehicle 1 on the basis of the received flight instruction information.

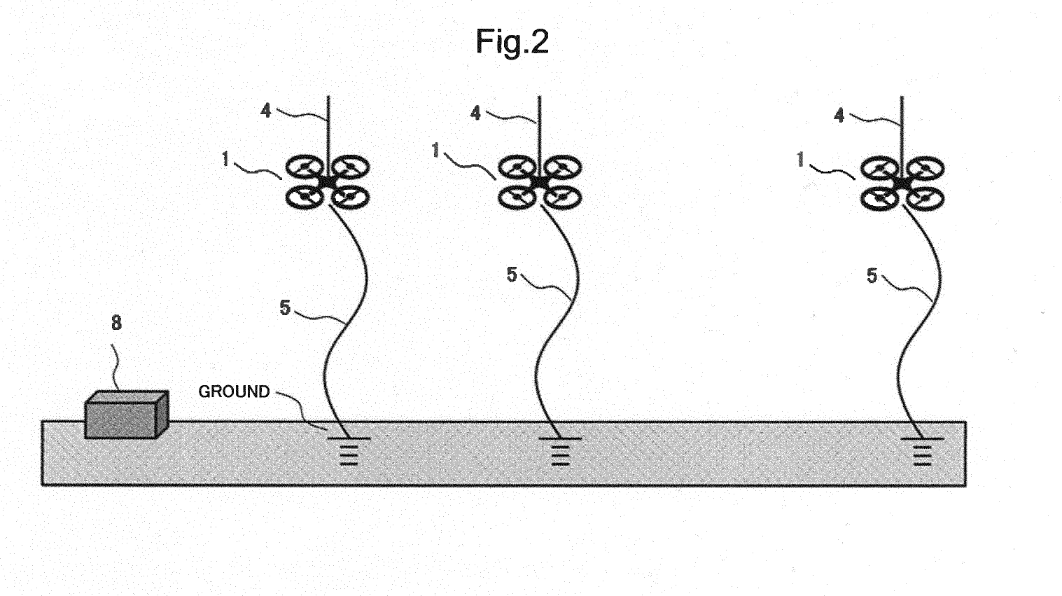

FIG. 2 is a conceptual diagram illustrating the configuration of an entire uninhabited aerial vehicle control system according to the exemplary embodiment of the disclosed subject matter.

The uninhabited aerial vehicle control system according to the exemplary embodiment of the disclosed subject matter includes at least an uninhabited aerial vehicle 1 and a ground station 8. The uninhabited aerial vehicle 1 serves as a flying object which autonomously flies in response to commands, such as a remote-controlled or autonomous quadcopter or multicopter.

(Action)

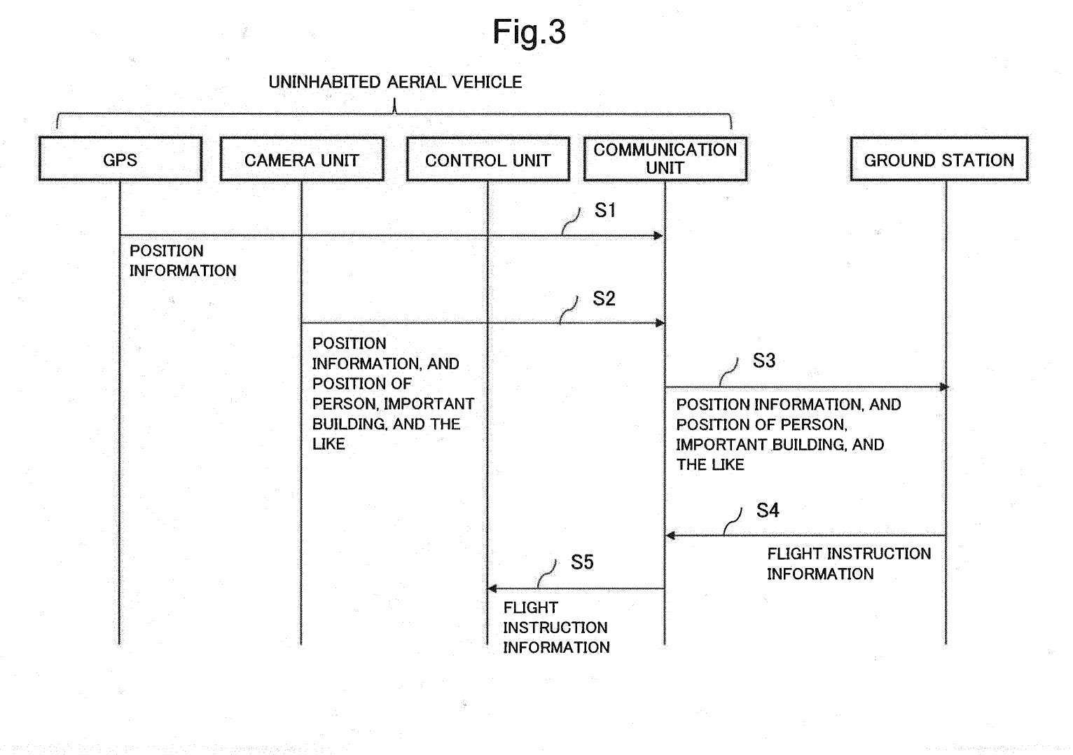

FIG. 3 is a sequence chart illustrating the operation of the uninhabited aerial vehicle control system according to the exemplary embodiment of the disclosed subject matter.

The uninhabited aerial vehicle 1 is made to fly for information collection. In this case, it is desired to uniformly distribute a plurality of uninhabited aerial vehicles 1 for information collection without leakage in a wider zone. The GPS 2 of the uninhabited aerial vehicle 1 calculates position information including the current position (longitude and latitude) and the altitude of the uninhabited aerial vehicle 1 and transmits the calculated position information to the communication unit 7 (step S1).

The camera unit 3 of the uninhabited aerial vehicle 1 detects a person, an important building, and the like from the captured image, calculates the position (longitude, latitude, and altitude) of the detected person, the detected important building, and the like, and transmits the calculated position (longitude, latitude, and altitude) of the person, the important building, and the like to the communication unit 7 (step S2).

The communication unit 7 transmits the position information received from the GPS 2 and the position (longitude, latitude, and altitude) of the person, the important building, and the like received from the camera unit 3 to the ground station 8 (step S3).

The ground station 8 calculates the position (longitude and latitude) and the altitude (flight instruction information) of the plurality of uninhabited aerial vehicles 1, at which all the objects to be protected fall within the lightning protection area, on the basis of the received position information and position (longitude, latitude, and altitude) of the person, the important building, and the like, and transmits the calculated flight instruction information to the communication unit 7 of each of the plurality of uninhabited aerial vehicles 1 (step S4).

Upon receiving the flight instruction information, the communication unit 7 transmits it to the control unit 6 (step S5). The control unit 6 performs control to shift and keep the position (longitude and latitude) and the altitude of the uninhabited aerial vehicle 1 on the basis of the received flight instruction information.

Each of the GPS 2 and the camera unit 3 periodically calculates position information or the position (longitude, latitude, and altitude) of the person, the important building, and the like, and transmits the position information or the position to the ground station 8 via the communication unit 7. The ground station 8 newly calculates flight instruction information on the basis of the received position information and position (longitude, latitude, and altitude) of the person, the important building, and the like, and transmits the calculated flight instruction information to the communication unit 7 of each of the plurality of uninhabited aerial vehicles 1. Upon receiving the flight instruction information, the communication unit 7 transmits it to the control unit 6. The control unit 6 controls the position (longitude and latitude) and the altitude of the uninhabited aerial vehicle 1 on the basis of the received flight instruction information. This enables controlling the uninhabited aerial vehicles 1 such that even when an object to be protected moves, the position of the objects to be protected after the movement falls within the lightning protection area.

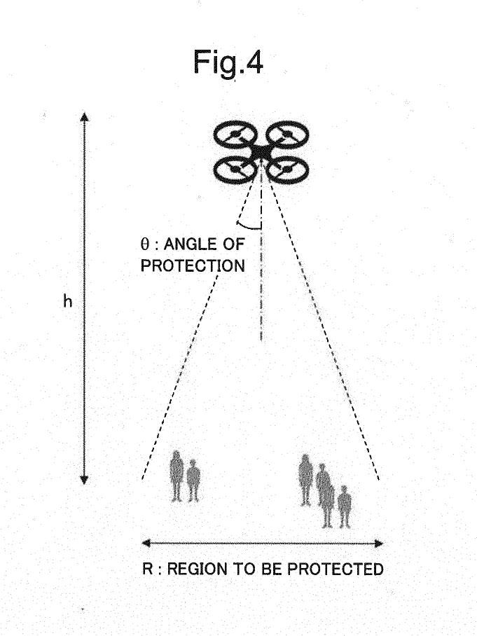

FIG. 4 is a diagram for explaining an exemplary method for calculating the position (longitude and latitude) and the altitude (flight instruction information) of the uninhabited aerial vehicle 1, which calculation method is conducted by the ground station 8 according to the exemplary embodiment of the disclosed subject matter.

For example, the ground station 8 determines a region to be protected R from the received position (longitude, latitude, and altitude) of the person, the important building, and the like. R is the one-dimensional length. The one-dimensional length will be described hereinafter. Letting 0 be the angle of protection of the lightning rod 4 and h be the flight altitude representing the altitude of the uninhabited aerial vehicle 1, the lightning protection area (length) of the lightning rod of the uninhabited aerial vehicle 1 is derived from a geometrical relationship as depicted in FIG. 4, as 2×h×tan θ. To make the region to be protected R fall within the lightning protection area, it suffices to satisfy 2×h×tan θ>R. Hence, the ground station 8 calculates minimum h that satisfies h>R/(2×tan θ).

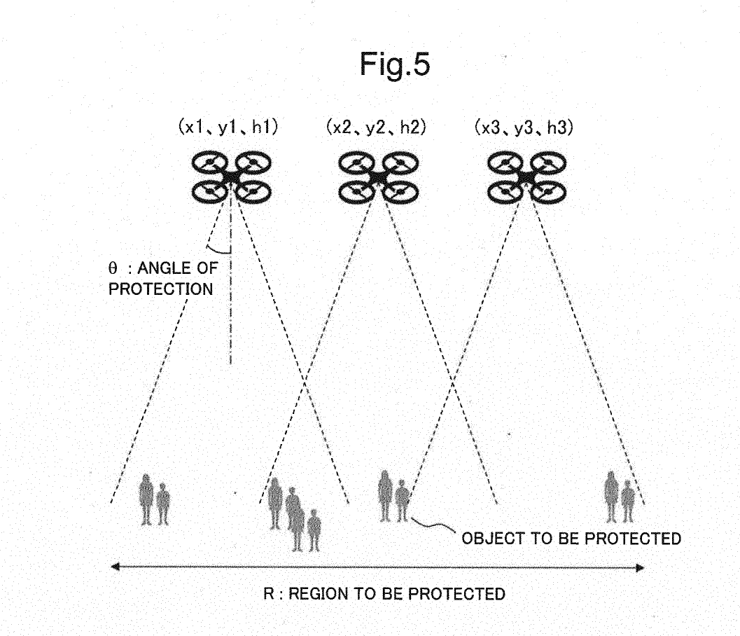

FIG. 5 is a diagram for explaining another exemplary method for calculating the position (longitude and latitude) and the altitude (flight instruction information) of the uninhabited aerial vehicle 1, which calculation method is conducted by the ground station 8 according to the exemplary embodiment of the disclosed subject matter.

When the region to be protected R is larger than one lightning protection area, it is covered by a plurality of uninhabited aerial vehicles 1. When the region to be protected R is large, the ground station 8, as illustrated in FIG. 5, determines the position and the altitude of the uninhabited aerial vehicles to cover the region to be protected R by overlapping the lightning protection areas of the lightning rods 4 of the plurality of uninhabited aerial vehicles 1. The number of uninhabited aerial vehicles 1 is defined as the number of flying drones N, and the ratio of the overlapping lightning protection area (length) to the sum of lightning protection areas (lengths) is defined as a factor of safety A. The factor of safety A is naturally 1 or less. The factor of safety A is determined in advance. The overlapping lightning protection area (length) is given by 2×h×tan θ×N×A. To make the region to be protected R fall within the overlapping lightning protection area, it suffices to satisfy 2×h×tan θ×N×A>R. Hence, the ground station 8 calculates minimum h that satisfies h>R/(2×tan θ×N×A).

When some uninhabited aerial vehicles 1 have become unable to maintain their altitude due to device failure or battery exhaustion, the ground station 8 calculates the position (longitude and latitude) and the altitude (flight instruction information) of the remaining uninhabited aerial vehicles 1 again.

As described above, the GPS 2 periodically calculates and transmits position information to the ground station 8 via the communication unit 7. Thus, the ground station 8 can always grasp the number of flying drones N. The ground station 8 can even detect some uninhabited aerial vehicles 1 which have become unable to maintain their altitude.

### Advantageous Effect

With the aforementioned arrangement, uninhabited aerial vehicles 1 can be deployed in the sky, and upon a thunderbolt, lightning is attracted to the lightning rod 4 of the uninhabited aerial vehicle 1 and safely guided to the ground via conducting wire 5.

In other words, according to this exemplary embodiment, a thunderbolt can be prevented at a location where no lightning rod can be placed at a high altitude. The uninhabited aerial vehicle 1 according to this exemplary embodiment has its position and altitude controlled such that the position of objects to be protected included in an image captured by the image capturing unit falls within the lightning protection area of the lightning rod of the uninhabited aerial vehicle 1. Hence, even when the position of the object to be protected changes, the lightning protection area of the lightning rod of the uninhabited aerial vehicle 1 can follow such changes.

The disclosed subject matter is not limited to the above-described exemplary embodiment, and various modifications can be made within the scope of the disclosed subject matter as defined in the appended claims and are also encompassed by the disclosed subject matter, as a matter of course.

1. An uninhabited aerial vehicle comprising:
a calculator configured to calculate position information indicating a position and an altitude of the uninhabited aerial vehicle;
an image capturing unit configured to capture an image;
a lightning rod that couples to a conducting wire with one end grounded;
a controller configured to control the position and the altitude of the uninhabited aerial vehicle; and
a communicator which performs information communication with an outside,
wherein the calculator transmits the position information to the communicator,
the image capturing unit calculates a position of an object to be protected against a thunderbolt from the captured image, and transmits the calculated position of the object to the communicator,
the communicator transmits the position information received from the calculator and the position of the object received from the image capturing unit to the outside, and receives flight instruction information based on the position information and the position of the object from the outside, and
the controller controls the position and the altitude of the uninhabited aerial vehicle based on received flight instruction information of the received flight instruction information.

2. An uninhabited aerial vehicle control system comprising:
an uninhabited aerial vehicle including a calculator configured to calculate position information indicating a current position and an altitude of the uninhabited aerial vehicle, image capturing means for capturing an image, a lightning rod that couples to a conducting wire with one end grounded, a controller configured to control the position and the altitude of the uninhabited aerial vehicle, and a communicator which performs information communication with an outside; and
a ground station,
wherein the calculator transmits the position information to the communicator,
wherein the image capturing unit calculates a position of an object to be protected against a thunderbolt from the captured image, and transmits the calculated position of the object to the communicator,
wherein the communicator transmits the position information received from the calculator and the position of the object received from the image capturing unit to the ground station,
wherein the ground station calculates flight instruction information based on the received position information and the received position of the object and transmits the calculated flight instruction information to the communicator,
the communicator receives the flight instruction information from the ground station, and
the controller controls the position and the altitude based on the received flight instruction information.

3. The uninhabited aerial vehicle control system according to claim 2, wherein the ground station determines a region to be protected from the received position of the object and calculates flight instruction information such that the determined region to be protected falls within a lightning protection area of the lightning rod.

4. The uninhabited aerial vehicle control system according to claim 2, wherein the uninhabited aerial vehicle comprises a plurality of uninhabited aerial vehicles, and the ground station determines a region to be protected from the received position of the object and calculates flight instruction information such that the region to be protected falls within an area obtained by overlapping lightning protection areas of lightning rods of the plurality of uninhabited aerial vehicles when the region to be protected is larger than a lightning protection area of one of the lightning rods.

5. An uninhabited aerial vehicle control method comprising:
calculating position information indicating a current position and an altitude;
capturing an image;
calculating a position of an object to be protected against a thunderbolt from the captured image;
transmitting the position information and the position of the object to an outside;
receiving flight instruction information based on the position information and the position of the object from the outside; and
controlling a position and an altitude of an uninhabited aerial vehicle based on the received flight instruction information.
